(19) United States
(12) Patent Application Publication
(10) Pub. No.: US 2026/0361010 A1
(43) Pub. Date: Nov. 12, 2026

(54) Electrical Connector Housing with Window to Facilitate Seating of Press Fit Contacts

(71) Applicant: TE Connectivity Solutions GmbH, Schaffhausen (CH)

(72) Inventor: Charles Raymond GINGRICH, III, Mechanicsburg, PA (US)

(73) Assignee: TE Connectivity Solutions GmbH, Schaffhausen (CH)

(21) Appl. No.: 19/199,536

(22) Filed: May 6, 2025

(51) Int. Cl. H01R 12/70; H01R 12/73; H01R 13/514; H01R 43/26

(52) U.S. Cl. CPC H01R 12/7005; H01R 12/737; H01R 13/514; H01R 43/26

(57) ABSTRACT

An electrical connector assembly having a housing with a plurality of wafer receiving cavities which extend from a mating end of the housing to a mounting end of the housing. A top surface of the housing is essentially parallel to and opposed to the mating end of the housing. A window is provided in the top surface of the housing extends through the top surface of the housing and into the wafer receiving cavities. A plurality of wafers are positioned in the wafer receiving cavities. The wafers have mating ends and mounting ends, top surfaces of the wafers are essentially parallel to and opposed to the mounting ends of the wafer. The top surfaces of the wafers extend into the window of the housing. A force is applied directly to the top surfaces of the wafers to properly seat the wafers with a mating substrate.

### FIELD OF THE INVENTION

The invention relates to an electrical connector housing which has a window to expose top sides of printed circuit board wafers positioned in the housing. The windows allow an application force to be applied directly to the top sides of the printed circuit board wafers, allowing the printed circuit board wafers to be properly seated when mated to a daughter card.

### BACKGROUND OF THE INVENTION

Interconnection systems or connectors are used to route signals from one electronic component to another. Because of the complexity of devices, the interconnection systems are often required to carry much data. Furthermore, this data is generally transmitted at a high data rate. There is simultaneously a need to make the systems as small as possible. As a result, there is a need to have interconnection systems that can carry many high speed signals in a relatively small space.

In order to accomplish the density and signal integrity requirements, the connectors utilize stacked printed circuit board wafers which are fully enclosed in the housing of the shroud housing or connector. The wafers have compliant pins at a mounting end which are positioned in thru-holes of a daughter card when the connector is mated to the daughter card. In order to fully mate the connector on the daughter card, a significant force needs to be applied to the housing, which is then translated to the floating printed circuit board wafers to cause all of the compliant pins to be fully seat the compliant pins in the thru-holes. However, due to the fact that the printed circuit board wafers must be able to have movement in the housing to compensate for mating variations with a mating connector, the application of a force to the housing does not always result in all of the compliant pins being fully seated in the thru-holes, which can lead to electrical and mechanical issues.

It would therefore be beneficial to provide a connector housing which allows insertion forces to be applied directly to surfaces of the floating printed circuit board wafers to ensure that the compliant pins are properly and fully seated in the thru-holes of the mated daughter card.

### SUMMARY OF THE INVENTION

The following provides a summary of certain illustrative embodiments of the present invention. This summary is not an extensive overview and is not intended to identify key or critical aspects or elements of the present invention or to delineate its scope.

An embodiment is directed to an electrical connector assembly having a housing with a plurality of wafer receiving cavities which extend from a mating end of the housing to a mounting end of the housing. A top surface of the housing is essentially parallel to and opposed to the mating end of the housing. A window is provided in the top surface of the housing and extends through the top surface of the housing and into the wafer receiving cavities. A plurality of wafers are positioned in the wafer receiving cavities. The wafers have mating ends and mounting ends, top surfaces of the wafers are essentially parallel to and opposed to the mounting ends of the wafer. The top surfaces of the wafers extend into the window of the housing. A force is applied directly to the top surfaces of the wafers to properly seat the wafers with a mating substrate.

An embodiment is directed to an electrical connector assembly having a housing with a plurality of wafer receiving cavities which extend from a mating end of the housing to a mounting end of the housing. The wafer receiving cavities extend in planes which are essentially parallel and spaced from adjacent wafer receiving cavities. The planes of the wafer receiving cavities extend in planes which are essentially perpendicular to a plane of the mounting end. A top surface of the housing is essentially parallel to and opposed to the mating end. A window is provided in the top surface of the housing and extends through the top surface of the housing and into the wafer receiving cavities. A plurality of wafers are positioned in the wafer receiving cavities. The wafers have mating ends and mounting ends, top surfaces of the wafers are essentially parallel to and opposed to the mounting ends of the wafer. The top surfaces of the wafers extend into the window of the housing. Mounting contacts are positioned at the mounting ends of the wafers. The mounting contacts have compliant mounting portions which extend from the mounting ends of the wafers. Applying a force directly to the top surfaces of the wafers causes the mounting ends of the mounting contacts to be inserted into thru-holes of a mating substrate.

An embodiment is directed to a method of mating an electrical connector assembly having wafers positioned in wafer receiving cavities with a substrate. The method includes: positioning compliant mounting portions of mounting contacts of the connector assembly in alignment with respective thru-holes of the substrate; positioning an insertion bar in an window of a housing of the connector assembly; moving the insertion bar into direct engagement with top surfaces of the wafers; and continue moving the insertion bar to apply a force to the wafer causing the wafer to be moved toward the substrate, causing the compliant mounting portions of the mounting contacts to move into and be fully seated in the respective thru-holes.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

FIG. 1 is a perspective view of an illustrative embodiment of connector with printed circuit board wafers positioned in a housing.

FIG. 2 is a cross-section view of the connector taken along line 2-2 of FIG. 1. is a perspective view of the connector of FIG. 1 prior to mating with an illustrative daughter card.

FIG. 3 is a perspective view of the connector of FIG. 1 prior to mating with an illustrative daughter card.

FIG. 4 is a perspective view of the connector of FIG. 1 mated with the daughter card, a force applicator is positioned in a window of the housing of the connector, the force applicator being in mechanical engagement with top surfaces of the printed circuit board wafers of the connector.

FIG. 5 is a cross-section view taken along line 5-5 of FIG. 4.

FIG. 6 is a cross-section view taken along line 6-6 of FIG. 4.

FIG. 7 is a perspective view of the connector of FIG. 4 mated with the daughter card, with the force applicator removed.

The accompanying drawings, which are incorporated into and form a part of the specification, schematically illustrate one or more exemplary embodiments of the invention and, together with the general description given above and detailed description given below, serve to explain the principles of the invention.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features, the scope of the invention being defined by the claims appended hereto.

Exemplary embodiments of the present invention are now described with reference to the Figures. Reference numerals are used throughout the detailed description to refer to the various elements and structures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

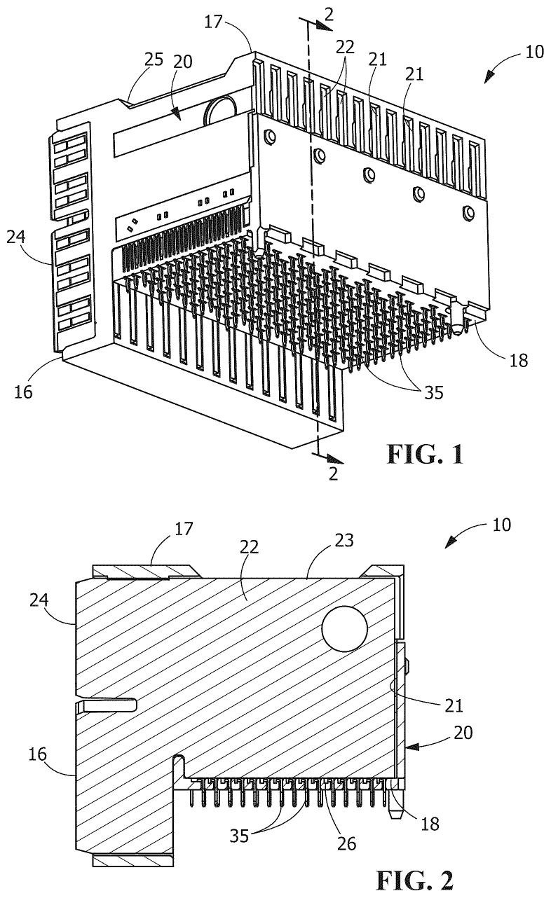

FIG. 1 illustrates an electrical connector assembly 10 formed in accordance with an illustrative embodiment. In the illustrative embodiment, the electrical connector assembly 10 is a daughtercard connector that can be mated to a mating backplane connector (not shown) to electrically connect a backplane circuit board (not shown) and a daughtercard circuit board (not shown). While the electrical connector assembly 10 is described herein with reference to a daughtercard connector, it is realized that the subject matter herein may be utilized with different types of electrical connectors other than a daughtercard connector. The daughtercard connector assembly 10 is merely illustrative of an illustrative embodiment of the type of electrical connector assembly 10 that mates with a mating connector.

In the illustrative embodiment shown, the connector assembly 10 constitutes a right angle connector wherein a mating end 16 and mounting end 18 of the connector assembly 10 are oriented perpendicular to one another. The connector assembly 10 is mounted to the daughtercard circuit board 19 at the mounting end 18. The connector assembly 10 is mounted to the mating connector (not shown) at the mating end 16. Other orientations of the ends 16, 18 are possible in alternative embodiments.

The connector assembly 10 includes a housing 20 having a plurality of wafer receiving cavities or slots 21 which extend from the mating end 16 to the mounting end 18. The wafer receiving cavities 21 extend in planes which are parallel and spaced from adjacent wafer receiving cavities 21. The planes of the wafer receiving cavities 21 extend in planes which are essentially perpendicular to a plane of the mounting end 18.

The housing 20 has a top surface 17 which is essentially parallel to and opposed to the mounting end 18. A window or recess 25 is provided in the top surface 17. The window 25 extends through the top surface 17 and into the wafer receiving cavities 21. A longitudinal axis 27 of the window 25 extends across the entire length of the housing 20.

A plurality of wafers, substrates or circuit boards 22 are retained in the housing 20. The wafers, substrates or circuit boards 22 are positioned in the wafer receiving cavities 21 and extend through the housing 20 from the mating end 16 to the mounting end 18. In the illustrative embodiment shown, the connector assembly 10 has fourteen wafer receiving cavities 21 and wafers 22, but other numbers of wafer receiving cavities 21 and wafers 22 may be provided. The wafers 22 extend in planes which are parallel and spaced from adjacent wafers 22.

Each of the wafers 22 has a mating end 24 configured to mate with the mating connector (not shown) and a mounting end 26 which is configured to mount to the daughtercard circuit board 19. The mating ends 24 extend from the mating end 16 of the connector assembly 10 and the mounting ends 26 extend from the mounting end 18 of the connector assembly 10.

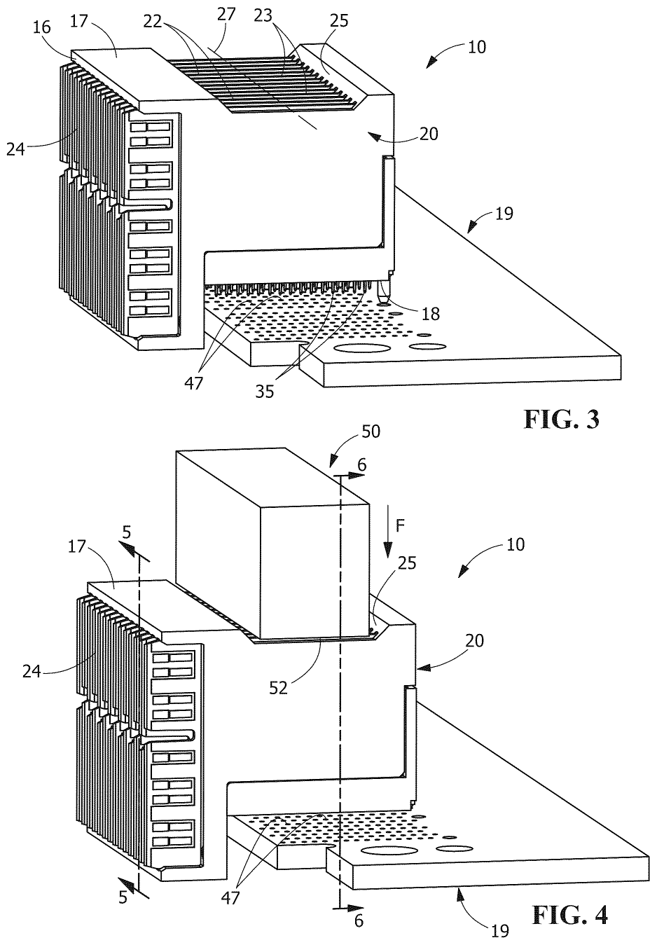

As shown in FIG. 3, the wafers 22 have top surfaces 23 which are essentially parallel to and opposed to the mounting ends 26. The top surfaces 23 extend into the window 25 of the housing 20.

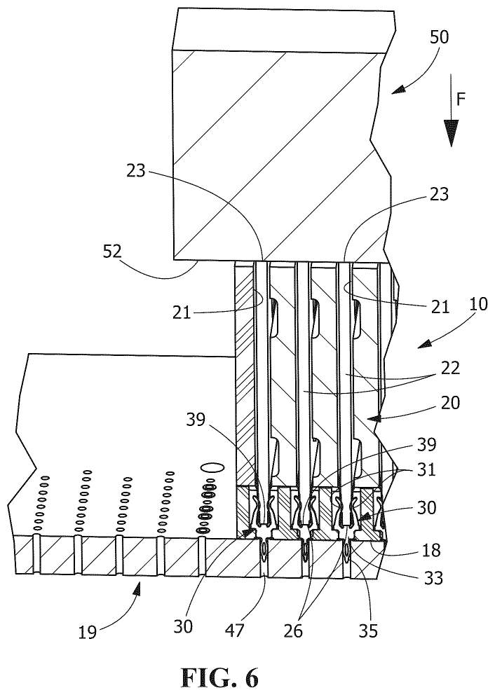

Each wafer 22 has a mounting contact 30 positioned at the mounting end 26. As shown in FIG. 6, the mounting contacts 30 have circuit board engaging resilient arms 31, securing sections 33 and compliant mounting portions 35. The circuit board engaging resilient arms 31 apply normal force to the electronic (signal/ground) pathways (not shown) positioned on sides of the wafers 22 to place the circuit board engaging resilient arms 31 in mechanical and electrical connection with the electronic pathways. This type of interference fit between the circuit board engaging resilient arms 31 and the pathways of the wafer 22 allows the wafer 22 to move or float relative to the mounting contacts 30 while still maintaining the electrical connection therebetween. In the embodiment shown, the compliant mounting portions 35 have an eye-of-the-needle configuration, but other types of compliant mounting portions 35 may be used.

With the wafers 22 properly positioned in the wafer receiving cavities 21 of the housing, the mounting contacts 30 are positioned in line with the window 25 of the housing 20. The width of the window 25 is sufficient to ensure that all of the mounting contacts 30 are positioned in line with the window 25.

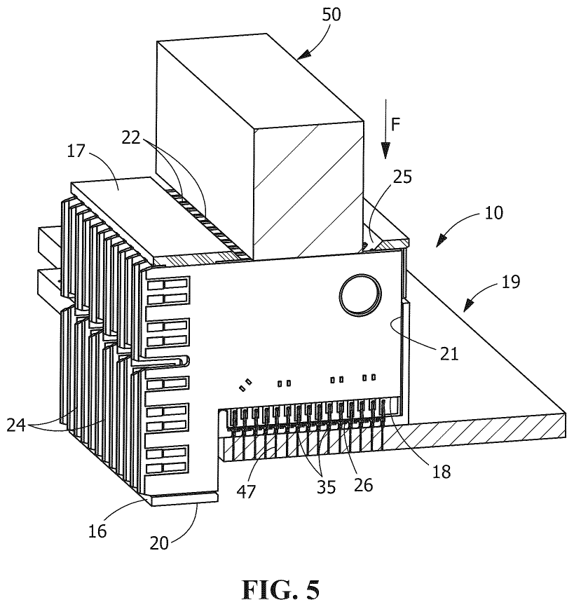

In use, the fully assembled connector assembly 10 is moved into position proximate the daughtercard circuit board 19, such that the compliant mounting portions 35 of the mounting contacts 30 are positioned in alignment with respective thru-holes 47 of the daughtercard circuit board 19, as shown in FIG. 2. In this position, an insertion bar 50 is moved into position proximate and in line with the window 25 of the housing 20, as shown in FIGS. 3 through 5.

The compliant mounting portions 35 of the mounting contacts 30 are partially inserted into respective thru-holes 47 of the daughtercard circuit board 19. The insertion bar 50 is moved toward the daughtercard circuit board 19. As the insertion bar 50 is positioned in alignment with the window 25, the continued movement of the insertion bar 50 causes the leading surface 52 of the insertion bar 50 to enter the window 25 and engage the top surfaces 23 of the wafers 22.

As the movement of the insertion bar 50 toward the daughtercard circuit board 19, the force F applied by the insertion bar 50 causes the floating wafers 22 to be moved downward until the mounting ends 26 engage push surfaces 39 of the securing sections 33 of the mounting contacts 30. With the mounting ends 26 of the wafer 22 in engagement with the push surfaces 39 of the securing sections 33, continued movement of the insertion bar 50 causes the compliant mounting portions 35 to move into and be fully seated in the respective thru-holes 47. As the insertion bar 50 is directly in line with the compliant mounting portions 35, the force applied by the insertion bar 50 to the top surfaces 23 is directly translated to the compliant mounting portions 35.

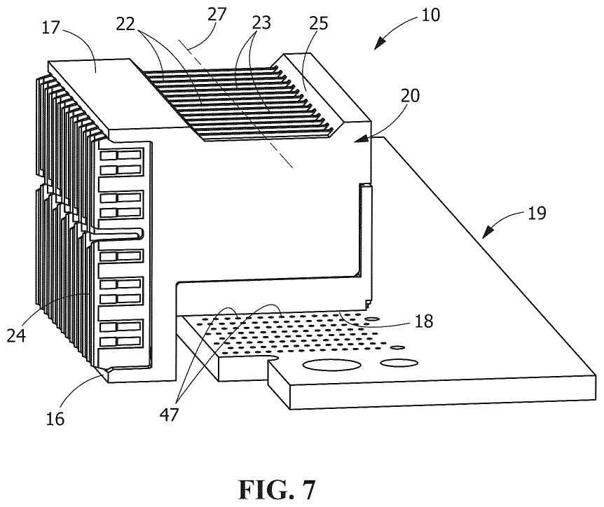

With the compliant mounting portions 35 of the mounting contacts 30 properly seated, the insertion bar 50 is moved away from the daughtercard circuit board 19 and out of the window 25, as shown in FIG. 7. With the force of the insertion bar 50 removed, the compliant mounting portions 35 remain fully inserted. However, with the force removed, the wafers 22 are allowed to move slightly in the direction of their longitudinal axes, thereby allowing the wafers 22 to float relative to the housing 20 to compensate for any misalignment of the connector assembly 10 with the mating backplane connector.

Applying the force directly to the top surfaces 23 of the wafers 22, allows the use of smaller compliant mounting portions 35 on the module contacts 30 which is beneficial for the signal integrity of the signal transmission which flow between the wafers 22 to the daughtercard circuit board 19. In addition, the configuration of the electrical connector assembly 10 allows direct force F to be applied to the top surfaces 23 of the wafers 22, eliminating the float of the wafer 22 temporarily during the application process described above, while allowing the float of the wafers 22 when the connector assembly 10 is fully seated on the daughtercard circuit board 19.

While the invention has been described with reference to a preferred embodiment, it will be understood by those skilled in the art that various changes may be made and equivalents may be substituted for elements thereof without departing from the spirit and scope of the invention as defined in the accompanying claims. One skilled in the art will appreciate that the invention may be used with many modifications of structure, arrangement, proportions, sizes, materials and components and otherwise used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

What is claimed:

1. An electrical connector assembly comprising:
a housing having a plurality of wafer receiving cavities which extend from a mating end of the housing to a mounting end of the housing;
a top surface of the housing is essentially parallel to and opposed to the mating end of the housing, a window provided in the top surface of the housing extends through the top surface of the housing and into the wafer receiving cavities;
a plurality of wafers positioned in the wafer receiving cavities, the wafers having mating ends and mounting ends, top surfaces of the wafers are essentially parallel to and opposed to the mounting ends of the wafer, the top surfaces of the wafers extend into the window of the housing;
whereby a force is applied directly to the top surfaces of the wafers to properly seat the wafers with a mating substrate.

2. The electrical connector assembly as recited in claim 1, wherein longitudinal axis of the window extends across the entire length of the housing.

3. The electrical connector assembly as recited in claim 1, wherein the wafers have mounting contacts positioned at the mounting ends of the wafers.

4. The electrical connector assembly as recited in claim 3, wherein the mounting contacts have circuit board engaging resilient arms, securing sections and compliant mounting portions.

5. The electrical connector assembly as recited in claim 4, wherein the circuit board engaging resilient arms apply normal force to the electronic pathways positioned on sides of the wafers to place the circuit board engaging resilient arms in mechanical and electrical connection with the electronic pathways.

6. The electrical connector assembly as recited in claim 5, wherein an interference fit is provided between the circuit board engaging resilient arms and the pathways of the wafer, wherein the wafer can move or float relative to the mounting contacts while still maintaining the electrical connection therebetween.

7. The electrical connector assembly as recited in claim 4, wherein the compliant mounting portions have an eye-of-the-needle configuration.

8. The electrical connector assembly as recited in claim 4, wherein the securing sections have push surfaces which engage the wafers as the wafers are forced toward the mounting end of the housing.

9. The electrical connector assembly as recited in claim 3, wherein the mounting contacts are positioned in line with the window of the housing.

10. The electrical connector assembly as recited in claim 1, wherein the connector assembly is a right angle connector wherein the mating end of the connector assembly and mounting end of the connector assembly are oriented perpendicular to one another.

11. An electrical connector assembly comprising:
a housing having a plurality of wafer receiving cavities which extend from a mating end of the housing to a mounting end of the housing, the wafer receiving cavities extend in planes which are essentially parallel and spaced from adjacent wafer receiving cavities, the planes of the wafer receiving cavities extend in planes which are essentially perpendicular to a plane of the mounting end;
a top surface of the housing is essentially parallel to and opposed to the mating end, a window provided in the top surface of the housing extends through the top surface of the housing and into the wafer receiving cavities;
a plurality of wafers positioned in the wafer receiving cavities, the wafers having mating ends and mounting ends, top surfaces of the wafers are essentially parallel to and opposed to the mounting ends of the wafer, the top surfaces of the wafers extend into the window of the housing;
mounting contacts positioned at the mounting ends of the wafers, the mounting contacts having compliant mounting portions which extend from the mounting ends of the wafers;
whereby applying a force directly to the top surfaces of the wafers causes the mounting ends of the mounting contacts to be inserted into thru-holes of a mating substrate.

12. The electrical connector assembly as recited in claim 11, wherein the mounting contacts are positioned in line with the window of the housing.

13. The electrical connector assembly as recited in claim 12, wherein securing sections of the mounting contacts have push surfaces which engage the wafers as the wafers are forced toward the mounting end of the housing.

14. The electrical connector assembly as recited in claim 13, wherein circuit board engaging resilient arms of the mounting contacts apply normal force to electronic pathways positioned on sides of the wafers to place the circuit board engaging resilient arms in mechanical and electrical connection with the electronic pathways.

15. The electrical connector assembly as recited in claim 14, wherein an interference fit is provided between the circuit board engaging resilient arms and the pathways of the wafer, wherein the wafer can move or float relative to the mounting contacts while still maintaining the electrical connection therebetween.

16. The electrical connector assembly as recited in claim 15, wherein the compliant mounting portions have an eye-of-the-needle configuration.

17. A method of mating an electrical connector assembly having wafers positioned in wafer receiving cavities with a substrate, the method comprising:
positioning compliant mounting portions of mounting contacts of the connector assembly in alignment with respective thru-holes of the substrate;
positioning an insertion bar in an window of a housing of the connector assembly;
moving the insertion bar into direct engagement with top surfaces of the wafers;
continue moving the insertion bar to apply a force to the wafer causing the wafer to be moved toward the substrate, causing the compliant mounting portions of the mounting contacts to move into and be fully seated in the respective thru-holes.

18. The method as recited in claim 11, wherein the mounting contacts are positioned in line with the window of the housing.

19. The method as recited in claim 11, wherein as the wafers are moved toward the substrate, the wafers engage push surfaces of securing sections of the mounting contacts.

20. The method as recited in claim 11, further comprising:
removing the insertion bar from the window, wherein the compliant mounting portions remain fully inserted and the wafers are allowed to move slightly in the direction of their longitudinal axes to allow the wafers to float relative to the housing to compensate for any misalignment of the connector assembly with mating connector.
